(19) United States
(12) Patent Application Publication
(10) Pub. No.: US 2022/0361986 A1
(43) Pub. Date: Nov. 17, 2022

(54) METHOD OF ASSEMBLY OF A DISTALIZER

(71) Applicant: Mark A. Payne, Oceanside, CA (US)

(72) Inventor: Mark A. Payne, Oceanside, CA (US)

(21) Appl. No.: 17/869,719

(22) Filed: Jul. 20, 2022

Related U.S. Application Data
(63) Continuation of application No. 17/137,102, filed on Dec. 29, 2020.

(51) Int. Cl. A61C 7/14; B33Y 80/00

(52) U.S. Cl. CPC A61C 7/14; B33Y 80/00

(57) ABSTRACT

A method of assembling a distalizer is provided. An arm is provided including a mesial element at one end of the arm, and a ball member at another end of the arm. The mesial element has a first base for attachment to a canine or bicuspid. A distal element is also provided having a second base for attachment to a molar. To assemble the distalizer, the ball member of the arm is enclosed in the distal element without deformation of the distal element. For instance, the ball member is inserted into a first portion of the distal element, and a second portion of the distal element is joined together with the first portion to form a receptacle for the ball member. The ball member is thus enclosed in the distal element without reducing an opening of a receptacle in the distal element. Thus, improved distalizer assembly and operation may result.

### CROSS REFERENCE TO RELATED APPLICATION(S)

This application is a continuation of U.S. application Ser. No. 17/137,102, entitled “DISTALIZER AND METHOD OF ASSEMBLY” and filed on Dec. 29, 2020, the disclosure of which is expressly incorporated by reference herein in its entirety.

### BACKGROUND

### Field

The disclosure is generally related to an orthodontic device and more particularly to an orthodontic appliance for molar distalization.

### INTRODUCTION

Molar distalization is form of orthodontic treatment which may be performed to correct Class 2 or Class 3 malocclusions in patients with misaligned teeth. During treatment, an appliance conventionally known as a distalizer is applied to the teeth to provide segmental distalization of the canine-to-molar posterior maxillary area or mandibular area. The distalizer generally includes a mesial element fixed to a canine or bicuspid, a distal element fixed to a molar, and an arm connecting the mesial element to the distal element. A ball member on the arm is received in the distal element to allow the ball member to rotate and upright with respect to the molar. A hook for an elastomer such as a rubber band may be fixed to the mesial element and to the distal element. Over time, distal rotational and up righting forces applied on the molar due to the connection between the mesial element and the distal element result in proper alignment of the teeth and correction of the malocclusion.

To allow the ball member to rotate with respect to the molar and enable the distalizer to perform its function of correcting Class 2 or Class 3 malocclusions, the ball member should be securely received in the distal element. In conventional distalizers, this retention is typically attempted by providing a distal element with a receptacle larger in width than the ball member, and after placing the ball member in the receptacle, deforming a portion of the distal element in order to retain the ball member within the receptacle. For example, deformation may be applied by crimping or coining a border of an opening for the receptacle, pushing in a flange delimiting the opening for the receptacle, deforming at least a portion of the border of the opening for the receptacle, or otherwise reducing the opening for the receptacle containing the ball member. However, using deformation to retain the ball member in the distal element requires precise measurements to prevent the ball member from slipping out of the distal element while also avoiding interference with movement of the ball member. For instance, if too little deformation is applied such that the width of the receptacle opening is still too large, the ball member may disconnect from the distal element, while if too much deformation is applied such that the width of the receptacle opening is too small, rotation of the ball member during distalization may be constrained by the deformed structure of the distal element.

Additionally, conventional distal elements are typically a single, integral unit, with at least a portion of the ball member generally being exposed after the ball member is placed within the receptacle of the distal element. As a result, since the ball member is not fully enclosed within the unitary distal element, a higher risk may exist of the ball member disconnecting from the distal element from an imprecise deformation. Additionally, while treatment is undergoing, forces applied to the molar may inadvertently expand the width of the receptacle opening, further countering the effect of the deformation. Thus, it would be helpful to eliminate distal element deformation in order to provide a more secure retention of the ball member.

### SUMMARY

Several aspects will be described more fully hereinafter with reference to various illustrative aspects of the present disclosure.

One aspect of a distalizer is disclosed herein. The distalizer comprises an arm including a mesial element at one end of the arm and a ball member at another end of the arm. The mesial element has a first base for attachment to a canine or bicuspid. The distalizer also comprises a distal element enclosing the ball member without deformation of the distal element. The distal element has a second base for attachment to a molar.

Another aspect of a method of assembling a distalizer is disclosed herein. An arm is provided with a mesial element at one end of the arm and a ball member at another end of the arm. The mesial element has a first base for attachment to a canine or bicuspid. The ball member is enclosed in a distal element without deformation of the distal element. The distal element has a second base for attachment to a molar.

A further aspect of a method of assembling a distalizer is disclosed herein. An arm is provided with a mesial element at one end of the arm and a ball member at another end of the arm. The mesial element has a first base for attachment to a canine or bicuspid. The ball member is inserted into a first portion of a distal element. The distal element has a second base for attachment to a molar. A second portion of the distal element is joined with the first portion to enclose the ball member in the distal element without deformation of the distal element.

An additional aspect of a method of assembling a distalizer is disclosed herein. A mesial element and a distal element are additively manufactured. An arm is additively manufactured simultaneously with the mesial element and the distal element. The mesial element is at one end of the arm, and the arm includes a ball member at another end of the arm. The mesial element has a first base for attachment to a canine or bicuspid, and the distal element has a second base for attachment to a molar. The ball member is enclosed in the distal element without deformation of the distal element during the additive manufacturing of the mesial element, the distal element, and the arm.

It is understood that other aspects of the distalizer will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the present invention will now be presented in the detailed description by way of example, and not by way of limitation, with reference to the accompanying drawings, wherein:

FIG. 1 is a perspective view of a distalizer including a ball member retained in a distal element without deformation.

FIGS. 2A and 2B are perspective and plan views of the distalizer of FIG. 1 illustrating separate portions of the distal element.

FIGS. 3A and 3B are conceptual diagrams illustrating an initial stage of the distalizer of FIG. 1 when the distalizer is additively manufactured.

FIGS. 4A and 4B are conceptual diagrams illustrating a middle stage of the distalizer of FIG. 1 when the distalizer is additively manufactured.

FIGS. 5A and 5B are conceptual diagrams illustrating a final stage of the distalizer of FIG. 1 when the distalizer is additively manufactured.

FIG. 6 is a flowchart illustrating an example method for assembling the distalizer of FIG. 1.

FIG. 7 is a flowchart illustrating another example method for assembling the distalizer of FIG. 1.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The words “exemplary” and “example” are used herein to mean serving as an example, instance, or illustration. Any exemplary embodiment described herein as “exemplary” is not necessarily to be construed as preferred or advantageous over other exemplary embodiments. Likewise, the term “exemplary embodiment” of an apparatus, method or article of manufacture does not require that all exemplary embodiments of the invention include the described components, structure, features, functionality, processes, advantages, benefits, or modes of operation.

In the following detailed description, various aspects of a distalizer will be presented. These aspects are well suited for distalizers that treat Class 2 malocclusions. However, those skilled in the art will realize that these aspects may be extended to distalizers for treating Class 3 malocclusions. Accordingly, any reference to a specific apparatus or method is intended only to illustrate the various aspects of the present invention, with the understanding that such aspects may have a wide range of applications without departing from the spirit and scope of the present disclosure.

An orthodontic appliance for molar distalization, also referred to herein as a distalizer, is provided. The distalizer includes an arm including a mesial element at one end of the arm which includes a first base for attachment to a canine or bicuspid, and a distal element enclosing a ball member at another end of the arm which includes a second base for attachment to a molar. The distal element encloses the ball member without deformation of the distal element. For example, the distal element may include a first portion and a second portion which are joined together to enclose the ball member. The first and second portions may be joined, for example, by one of snapping, welding, or adhesive. For instance, the first portion of the distal element may include one or more recesses, and the second portion of the distal element may include one or more protrusions, and the one or more protrusions may be snapped, welded, or adhered to the one or more recesses to join the first portion with the second portion.

A method for assembling the orthodontic appliance for molar distalization or distalizer is also provided. The method includes providing an arm with a mesial element at one end of the arm and a ball member at another end of the arm. The mesial element has a first base for attachment to a canine or bicuspid. The method further includes enclosing the ball member in a distal element having a second base for attachment to a molar. The ball member is enclosed in the distal element without deformation of the distal element. For example, the method may include inserting the ball member into a first portion of the distal element, and then joining a second portion of the distal element with the first portion. For example, the second portion of the distal element may be joined to the first portion of the distal element by one of snapping, welding, or adhesive. For instance, the method may include attaching one or more protrusions in the second portion of the distal element to one or more recesses in the first portion of the distal element. The first portion may be snapped, welded, or adhered to the second portion of the distal element, for example, using the protrusions or recesses.

The first portion and the second portion of the distal element may also each include a ridged base for attachment to the molar. The first portion and the second portion of the distal element may be metallic, polymeric, ceramic, or a combination of metallic, polymeric or ceramic. The first portion and the second portion of the distal element may together form a receptacle having a shape, such as a spherical shape, that is complementary to a shape of the ball member.

Another method for assembling the orthodontic appliance for molar distalization or distalizer is also provided. The method includes additively manufacturing a mesial element, an arm connected to the mesial element at one end of the arm, a ball member at another end of the arm, and a distal element enclosing the ball member. The mesial element has a first base for attachment to a canine or bicuspid, and the distal element has a second base for attachment to a molar. A support structure for the arm and mesial element is also additively manufactured with the distal element. During additive manufacturing of the distal element and ball member, the distal element encompasses the ball member, after which the support structure is removed. As a result, the distal element encloses the ball member without deformation of the distal element.

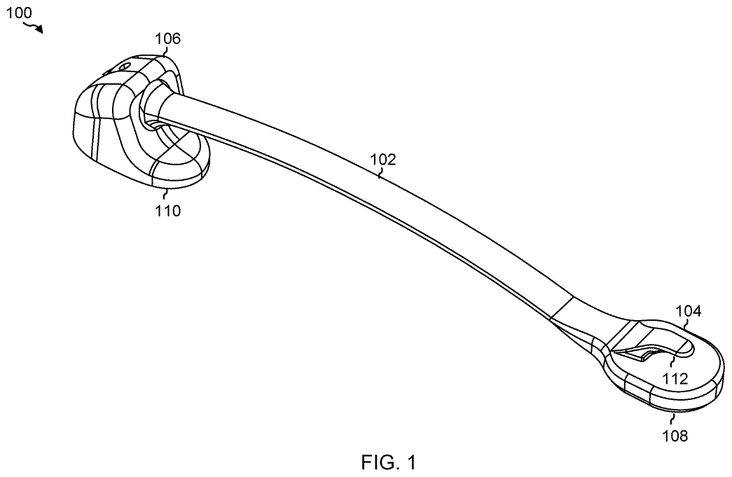

Referring to FIG. 1, a distalizer 100 is provided including an arm 102, a mesial element 104, and a distal element 106. The mesial element includes a first base 108 for attachment to a canine or bicuspid, and the distal element includes a second base 110 for attachment to a molar (e.g., a first molar). The first and second base may be ridged. The canine/bicuspid and molar may both be maxillary (e.g. upper jaw) or mandibular (e.g., lower jaw). The arm includes an arched shape and is connected between the mesial element and distal element. A hook 112 may be fixed to the mesial element for receiving an elastic member, such as a spring.

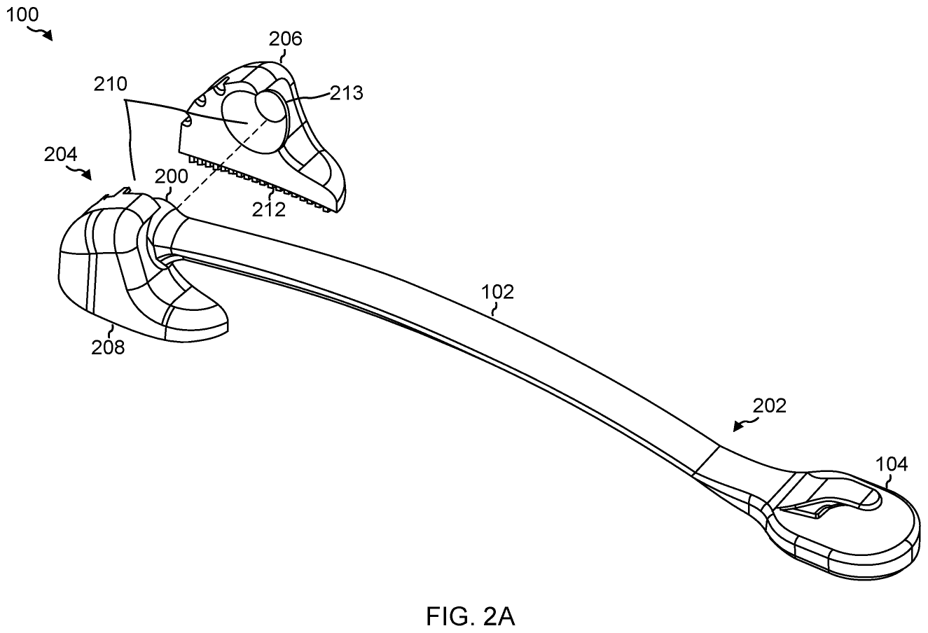

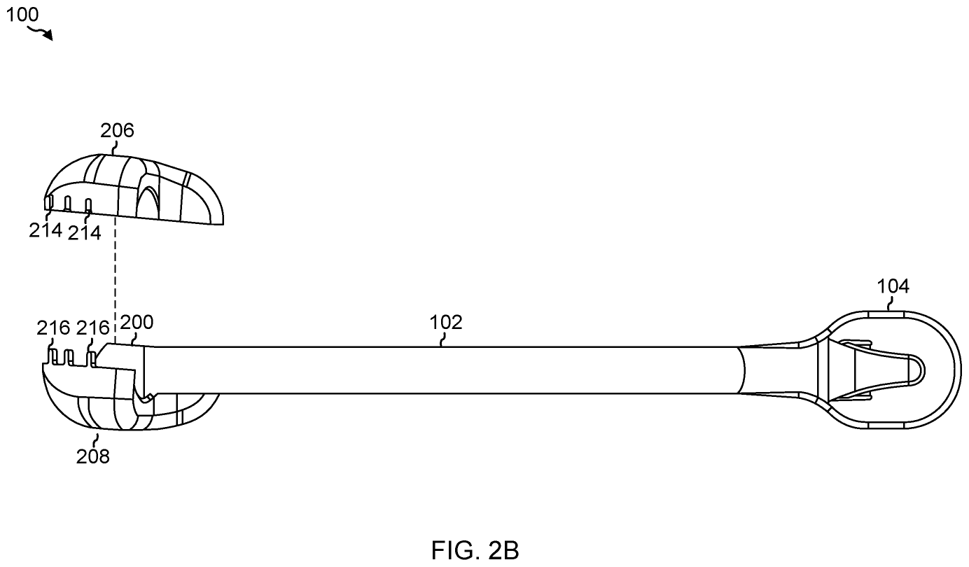

Referring to FIGS. 2A and 2B, the arm 102 includes a ball member 200. The mesial element 104 is at one end 202 of the arm, and the ball member is at another end 204 of the arm. While FIGS. 2A and 2B illustrate an example where the ball member shares an axis with the arm, the ball member in other examples may be angled with respect to the arm. For instance, the ball member may be angled by five or some other number of degrees with respect to the arm.

The distal element 106 also includes a first portion 206 and a second portion 208. The first and second portion together form a receptacle 210 having a shape that is complementary to a shape of the ball member. For example, the receptacle and ball member may both have a spherical shape. The first portion and the second portion also may each include a ridged base 212 for attachment to the molar. Thus, the ridged base 212 of the first portion and second portion may together comprise the second base 110 of the distal element. Alternatively, only one of the first portion or second portion may include ridged base 212. Moreover, the first and second portion may be metallic, polymeric (e.g., plastic), ceramic, or a combination of metallic, polymeric or ceramic. For instance, the first portion may be of a single material that is different than that of the second portion, or the first and second portion may each be comprised of a same or different combination of multiple materials. Additionally, while FIGS. 2A and 2B illustrate a particular example where the first portion is a lingual portion and the second portion is a labial portion, the first and second portions are not so limited. For instance, the second portion may be the lingual portion and the first portion may be the labial portion. Alternatively, the distal element may be separated gingival-occlusal, rather than lingual-labial, such that the first portion is an occlusal portion and the second portion is a gingival portion, or vice-versa.

When the first portion 206 and the second portion 208 are joined together, the first and second portion enclose the ball member 200 in the distal element 106 without exposing the ball member (see FIG. 1). Thus, the distalizer 100 encloses the ball member in the receptacle 210 of the distal element without deformation of the distal element. For example, no crimping, coining, heating, or other deformation is applied to the distal element (e.g., to a border of an opening 213 of the receptacle) after the ball member is inserted into the receptacle in order to secure the ball member within the receptacle. Rather, as illustrated in the example of FIGS. 2A-2B, the ball member may be inserted into the second portion (or the first portion) and then that portion may be joined with the first portion (or the second portion) to enclose the ball member. For example, the first and second portions may be joined by snapping the portions together, welding the portions together, adhering the portions together, or otherwise attaching the two portions. For instance, as illustrated in FIG. 2B, the first portion may include one or more recesses 214 which receive one or more protrusions 216 of the second portion. The protrusions may then be attached together by snapping, welding, and/or adhering the protrusions to the recesses. The first and second portions may alternatively be attached together in other manners (e.g., laser welding, tack welding, ultrasonic welding, etc.). Accordingly, by enclosing the ball member in the receptacle without deformation, the risk of the ball member slipping out of the receptacle may be reduced, and thus a more secure retention of the ball member to the distal element may result.

In one example, the arm 102, mesial element 104, and distal element 106 may be separately manufactured, and the distalizer 100 may be assembled by enclosing the ball member 200 of the arm in the distal element 106, for example, by joining separately manufactured first portion 206 and second portion 208. For example, the arm, mesial element, and distal element (including the first portion and second portion) may be additively manufactured (e.g., three-dimensionally (3D) printed) as individual components, and the individual components may be assembled together to form the distalizer as described above with respect to FIGS. 1, 2A and 2B.

In another example, the distalizer 100 may be additively manufactured as a single unit, with the ball member 200 already enclosed in the distal element 106 as a result of the additive manufacturing process. As an example of this additive manufacturing, a processor of a computing system may generate or obtain a computer-aided-design (CAD) of the distalizer that slices the design of the distalizer including the distal element, ball member, arm, and mesial element into multiple layers, and a depositor (e.g., a nozzle or a print head) in communication with the processor may selectively deposit material (e.g., wire or powder) in successive layers according to the design model. Alternatively or additionally, a laser or electron beam in communication with the processor may selectively melt or partially melt material layer-by-layer according to the design model. The layers of deposited or melted material are allowed to cool and fuse together to form the 3D-printed object, after which any existing support structures for the object or other excess material are removed (e.g., by vacuum or other process).

The distalizer 100 may thus be additively manufactured as a single unit according to any one of various additive manufacturing (AM) processes, for example, using powder bed fusion (PBF), binder jetting, directed energy deposition (DED), material extrusion, material jetting, vat polymerization, sintering, direct metal laser sintering (DMLS), direct metal laser melting (DMLM), electron beam melting (EBM), or stereolithography (SLA). Moreover, the material used during additive manufacturing of distalizer 100 according to any one of these AM processes may include metal, ceramic, polymeric, or a combination of these or other materials. Furthermore, the distalizer may be printed layer-by-layer in various orientations. For example, each layer of the distalizer may be printed in the occlusal-gingival direction, and the material of each layer may be deposited or melted first in the distal-mesial direction and then in the labial-lingual direction. Alternatively, the depositing or melting of material and accumulation of layers may be formed in other orientations.

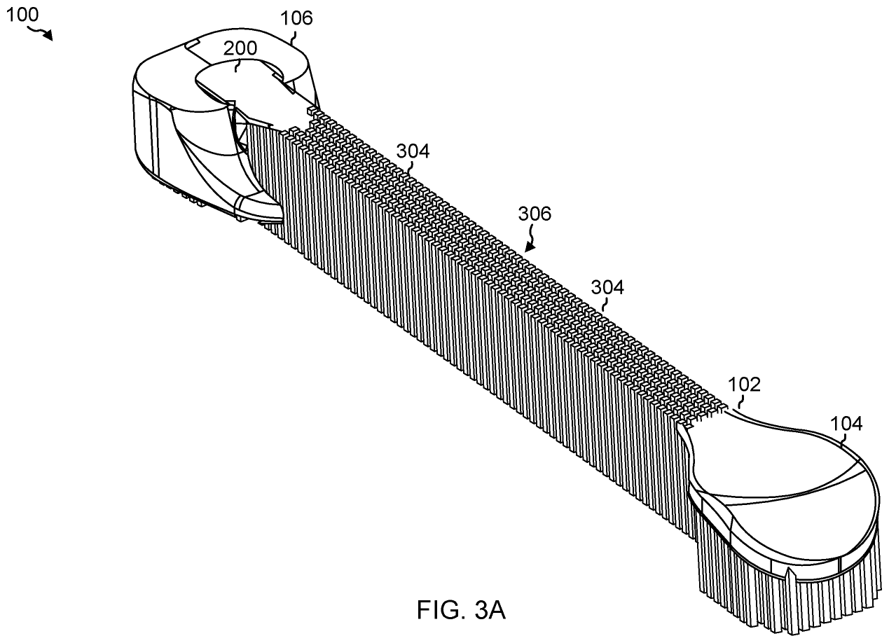

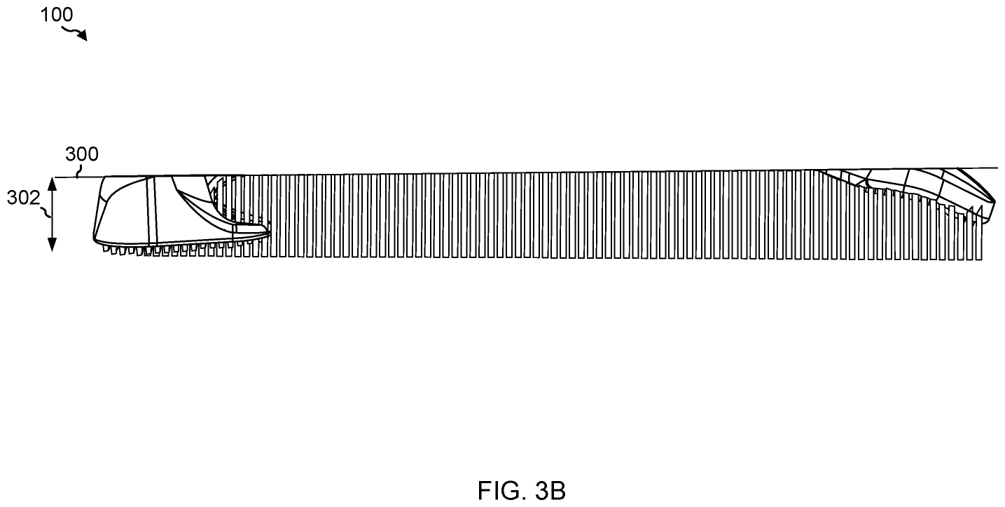

FIGS. 3A-3B illustrate an example of an initial additive manufacturing stage of distalizer 100 when the distalizer is 3D printed as a single unit. In this example, layer 300 of distalizer 100 (see FIG. 3B) has been printed subsequent to multiple preceding slices or layers 302 of distalizer 100. For instance, at the time depicted in FIGS. 3A-3B, a depositor or electron beam may selectively deposit or melt layer 300 of material, one layer segment 304 at a time, for various components of distalizer 100 including arm 102, mesial element 104, distal element 106, and ball member 200. Moreover, layer 300 may include material for distalizer support structure 306 to support successive slices or layers of the distalizer components. As can be seen in this example, portions of arm 102, mesial element 104, distal element 106, ball member 200, and distalizer support structure 306 may be simultaneously printed during this initial additive manufacturing stage, with the currently printed portions of ball member 200 encompassed in the currently printed portions of distal element 106.

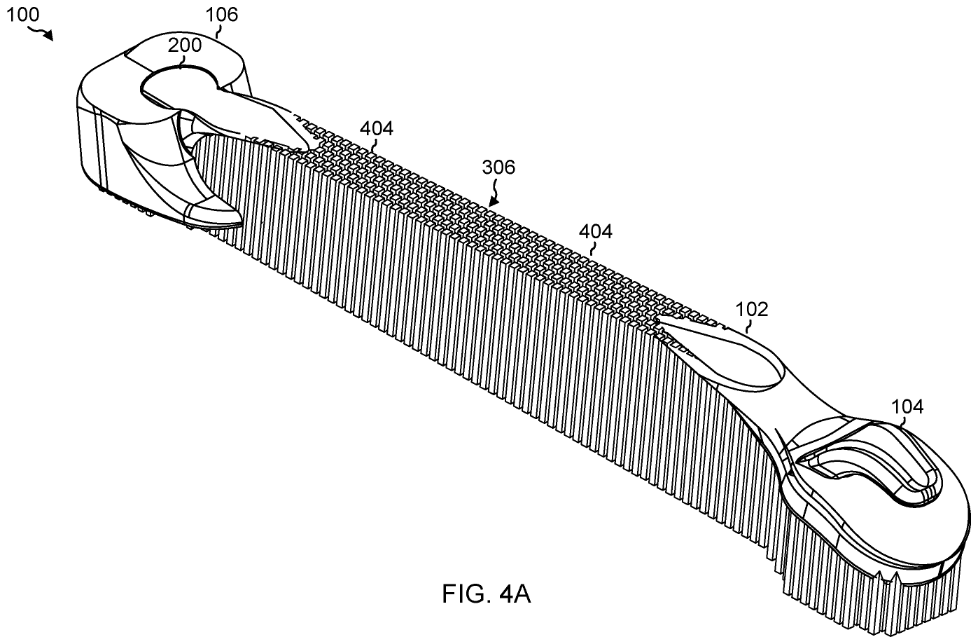

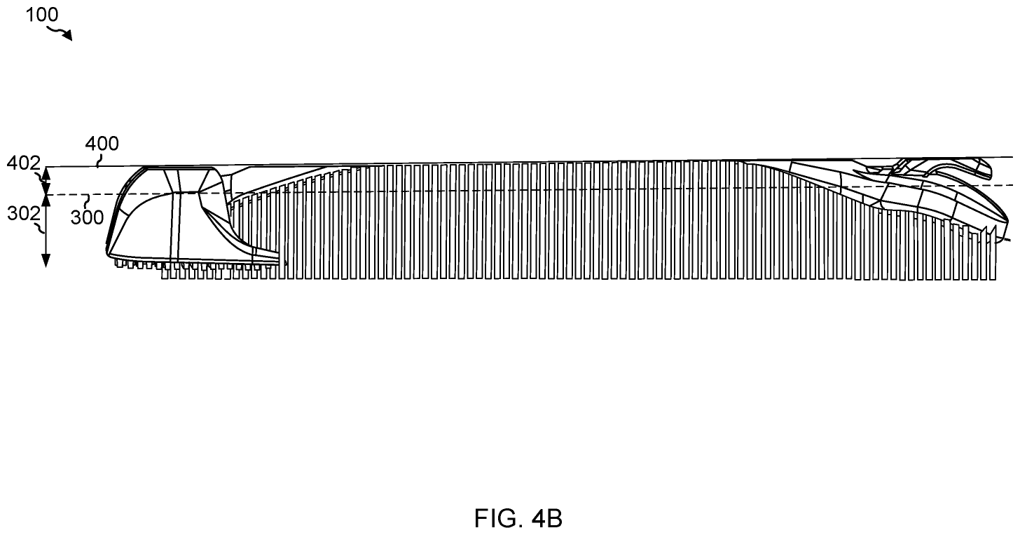

FIGS. 4A-4B illustrate an example of a middle additive manufacturing stage of distalizer 100 when the distalizer is 3D printed as a single unit. In this example, layer 400 of distalizer 100 (see FIG. 4B) has been printed subsequent to layer 300 as well as other preceding slices or layers 402 of distalizer 100. For example, at the time depicted in FIGS. 4A-4B, the depositor or electron beam may selectively deposit or melt layer 400 of material, one layer segment 404 at a time, for various components of distalizer 100 including arm 102, mesial element 104, distal element 106, and distalizer support structure 306. As can be seen in this example, portions of arm 102, mesial element 104, distal element 106, and distalizer support structure 306 may be simultaneously printed during this middle additive manufacturing stage, again with the ball member 200 encompassed in the currently printed portions of distal element 106.

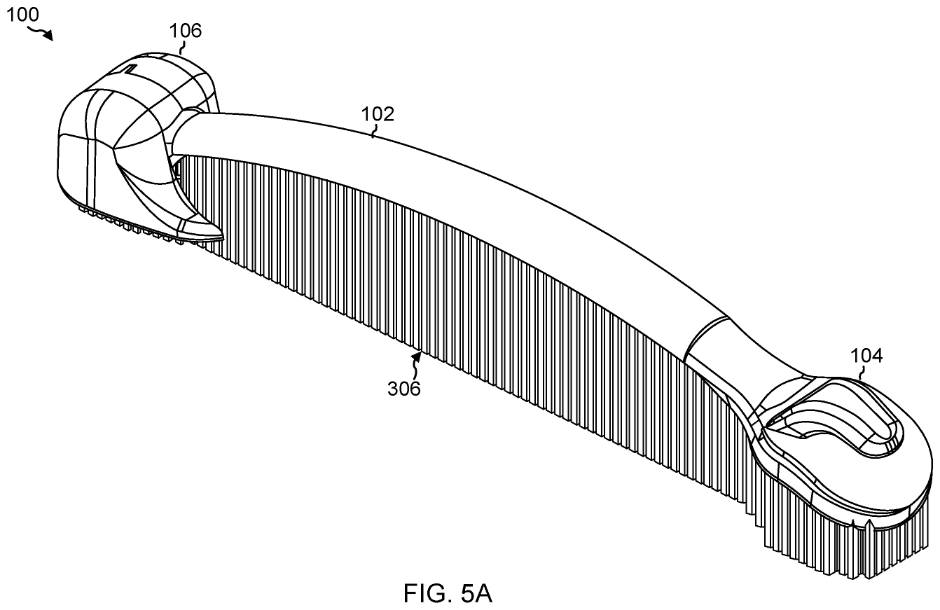

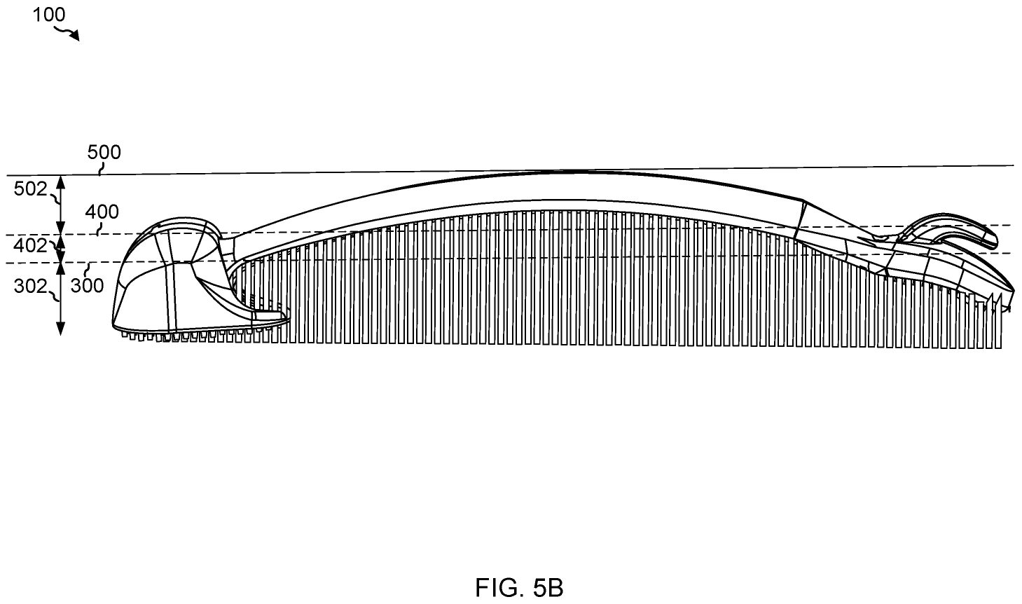

FIGS. 5A-5B illustrate an example of a final additive manufacturing stage of distalizer 100 when the distalizer is 3D printed as a single unit. In this example, layer 500 of distalizer 100 (see FIG. 5B) has been printed subsequent to layer 400 as well as other preceding slices or layers 502 of distalizer 100. For example, at the time depicted in FIGS. 5A-5B, the depositor or electron beam may selectively deposit or melt layer 500 of material, one layer segment at a time, for one or more components of distalizer 100 including arm 102. As a result, ball member 200 is enclosed in distal element 106 during additive manufacturing of distalizer 100 without deformation of the distal element, thus reducing the risk of the ball member 200 slipping out of the distal element 106. After all layers of distalizer 100 have been printed including layers 300, 400, 500 and any preceding and intervening layers (e.g., layers 302, 402, 502), distalizer support structure 306 is removed, and the completed product is formed.

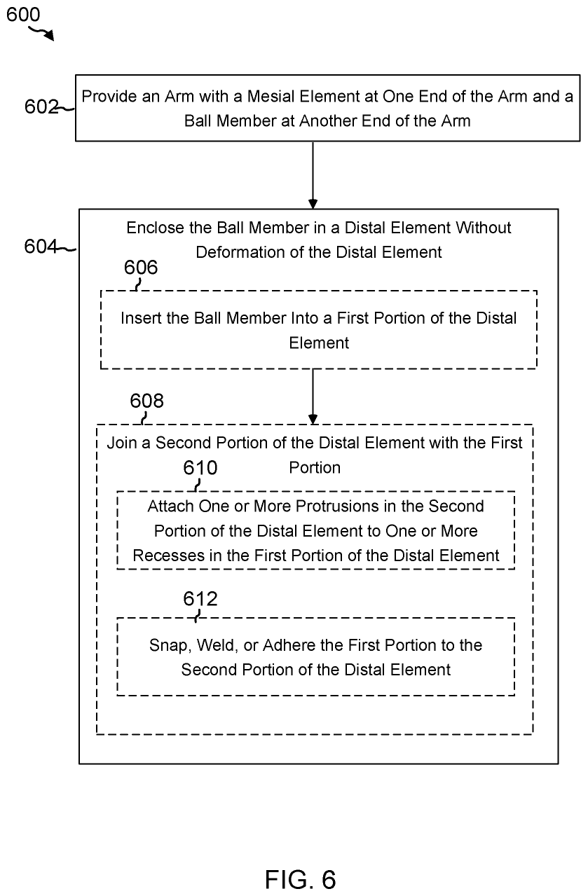

FIG. 6 is a flow diagram illustrating a method 600 of assembling a distalizer as described in the example of FIGS. 1 and 2A-2B (e.g., distalizer 100). The method may be performed by a manufacturer or assembler, for example. Optional aspects are illustrated in dashed lines.

As represented by block 602, an arm is provided with a mesial element at one end of the arm and a ball member at another end of the arm. Then, as represented by block 604, the ball member is enclosed in a distal element without deformation of the distal element. For instance, referring to FIGS. 1, 2A and 2B, distalizer 100 may be assembled by providing arm 102 with mesial element 104 at one end 202 of the arm and with ball member 200 at another end 204 of the arm, and then by enclosing ball member 200 in distal element 106 without deforming the distal element.

For example, as represented by blocks 606 and 608, the ball member may be enclosed in the distal element by inserting the ball member into a first portion of the distal element and joining a second portion of the distal element with the first portion, respectively. For instance, referring to FIGS. 1, 2A and 2B, the ball member may be inserted into first portion 206 of distal element 106, and second portion 208 of distal element 106 may then be joined with first portion 206 to enclose ball member 200 in distal element 106.

The second portion of the distal element may be joined to the first portion of the distal element by one of snapping, welding or adhesive. For instance, as represented by block 610, the second portion may be joined with the first portion by attaching one or more protrusions in the second portion of the distal element to one or more recesses in the first portion of the distal element. In another example, as represented by block 612, the second portion may be joined with the first portion by snapping, welding, or adhering the first portion to the second portion of the distal element. For example, referring to FIGS. 1, 2A and 2B, second portion 208 of distal element 106 may be joined with first portion 206 of distal element 106 by attaching protrusions 216 to recesses 214, or by snapping, welding, or adhering first portion 206 to second portion 208. Thus, ball member 200 may be securely enclosed in distal element 106.

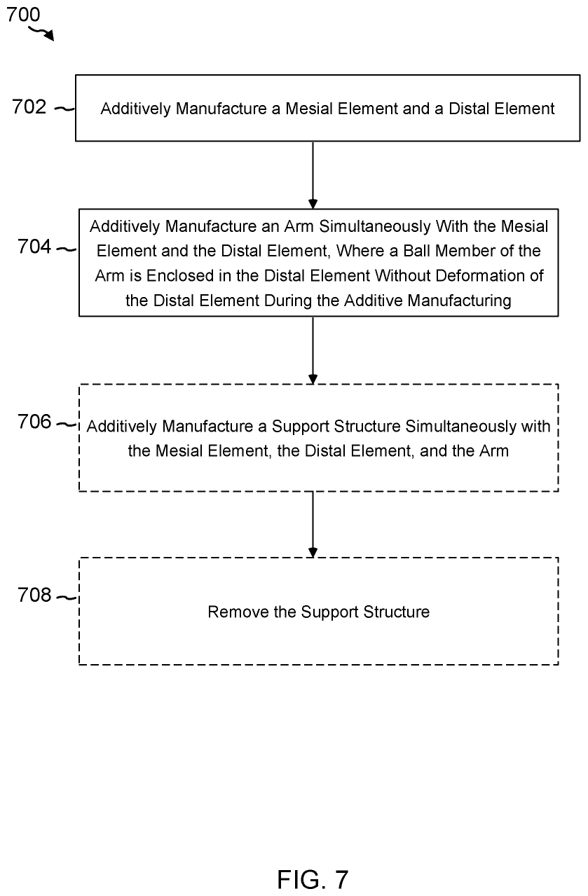

The distalizer may also be additively manufactured. In one example, the mesial element, the arm including the ball member, and the distal element (including first and second portions) may be additively manufactured as individual components, and the ball member may be enclosed in the distal element by joining the first and second portions together. In another example, the mesial element, the arm including the ball member, and the distal element may be additively manufactured as a single unit, and the ball member may be enclosed in the distal element as part of the additive manufacturing process. For example, referring to FIGS. 1 and 3A-5B, distalizer 100 including mesial element 104, distal element 106, and arm 102 with ball member 200 may be 3D printed, simultaneously, with the ball member enclosed in the distal element. More details of this process are described below with respect to FIG. 7.

FIG. 7 is a flow diagram illustrating a method 700 of assembling a distalizer as described in the example of FIGS. 1 and 3A-5B (e.g., distalizer 100). The method may be performed by a manufacturer or assembler using additive manufacturing. Optional aspects are illustrated in dashed lines.

As represented by block 702, a mesial element and a distal element are additively manufactured. The mesial element has a first base for attachment to a canine or bicuspid, and the distal element has a second base for attachment to a molar. The second base may be ridged for attachment to the molar. For instance, referring to FIGS. 1 and 3A-5B, mesial element 104 and distal element 106, including first base 108 and second base 110, may be 3D printed in multiple layers 300, 302, 400, 402, 500, 502 using PBF, DED, or other AM process. Ridges on first base 108 and second base 110 may similarly be additively manufactured.

As represented by block 704, an arm is additively manufactured simultaneously with the mesial element and the distal element. The mesial element is at one end of the arm, and the arm includes a ball member at another end of the arm. For example, referring to FIGS. 1 and 3A-5B, arm 102 including ball member 200 may be 3D printed along with mesial element 104 and distal element 106 in multiple layers 300, 302, 400, 402, 500, 502 using PBF, DED, or other AM process. While the mesial element, the distal element, and the arm are additively manufactured, ball member 200 is enclosed in distal element 106 without deformation of distal element 106. Mesial element 104, distal element 106, and arm 102 including ball member 200 enclosed in distal element 106 may thus be additively manufactured as a unit (e.g., a single 3-D printed unit). Additionally, ball member 200 may have a spherical shape, and distal element 106 may comprise a receptacle having a shape that is complementary to the spherical shape of the ball member.

As represented by block 706, a support structure may be additively manufactured simultaneously with the mesial element, the distal element, and the arm. For example, referring to FIGS. 3A-5B, support structure 306 may be 3D printed along with mesial element 104, distal element, and arm 102 in multiple layers 300, 302, 400, 402, 500, 502 using PBF, DED, or other AM process. Additionally, as represented by block 708, the support structure may be removed after additively manufacturing the mesial element, the distal element, and the arm. For example, referring to FIGS. 5A and 5B, after all layers of distalizer 100 have been printed including layers 300, 302, 400, 402, 500, 502, distalizer support structure 306 may be removed and the completed distalizer may accordingly be formed.

Thus, the distalizer of the present disclosure allows a more secure retention of the ball member within a distal element to be realized. For example, by not deforming the distal element to retain the ball member, the risk of the ball member slipping out of the distal element may be reduced. Such risk may further be reduced by joining separate portions of a non-unitary distal element together to fully enclose the ball member, which may allow for improved retention of the ball member over conventional distalizers having unitary distal elements with exposed ball members. Additionally, a unitary distal element may be additively manufactured (e.g., 3D printed) to enclose the ball member without relying on deformation in order to securely retain the ball member. As a result, improved distalizer assembly and operation may result.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) in the United States, or an analogous statute or rule of law in another jurisdiction, unless the element is expressly recited using the phrase “means for” or, in the case of a method claim, the element is recited using the phrase “step for.”

What is claimed is:

1. A method of assembling a distalizer, comprising:
providing an arm with a mesial element at one end of the arm and a ball member at another end of the arm, the mesial element having a first base for attachment to a canine or bicuspid; and
enclosing the ball member in a distal element without deformation of the distal element, the distal element having a second base for attachment to a molar.

2. The method of claim 1, wherein the ball member is enclosed in the distal element without exposure of the ball member.

3. The method of claim 1, wherein the enclosing comprises:
inserting the ball member into a first portion of the distal element; and
joining a second portion of the distal element with the first portion.

4. The method of claim 3, wherein the first portion and the second portion of the distal element together form a receptacle having a shape that is complementary to a shape of the ball member.

5. The method of claim 4, wherein the ball member is enclosed in the distal element without reducing an opening of the receptacle.

6. The method of claim 3, wherein the second portion of the distal element is joined to the first portion of the distal element by one of snapping, welding, or adhesive.

7. The method of claim 3, wherein the joining comprises:
attaching one or more protrusions in the second portion of the distal element to one or more recesses in the first portion of the distal element; or
attaching one or more protrusions in the first portion of the distal element to one or more recesses in the second portion of the distal element.

8. The method of claim 3, wherein the first portion and the second portion of the distal element each include a base for attachment to the molar, the second base being formed from a combination of the bases as a result of the joining.

9. The method of claim 8, wherein at least one of the bases of the first portion and the second portion is a ridged base.

10. The method of claim 3, wherein the enclosing further comprises:
additively manufacturing the first portion and the second portion prior to the inserting and the joining.

11. The method of claim 1, wherein the providing comprises:
additively manufacturing the arm with the mesial element.

12. A method of assembling a distalizer, comprising:
providing an arm with a mesial element at one end of the arm and a ball member at another end of the arm, the mesial element having a first base for attachment to a canine or bicuspid;
enclosing the ball member in a distal element without deformation of the distal element, the distal element having a second base for attachment to a molar, wherein the enclosing comprises:
inserting the ball member into a first portion of the distal element; and
joining a second portion of the distal element with the first portion;
wherein a base of the first portion and a base of the second portion together comprise the second base of the distal element.

13. The method of claim 12, wherein the ball member is enclosed in the distal element without exposure of the ball member as a result of the joining.

14. The method of claim 12, wherein the first portion and the second portion of the distal element together form a receptacle having a shape that is complementary to a shape of the ball member as a result of the joining.

15. The method of claim 12, wherein the ball member is enclosed in the distal element without reducing an opening of a receptacle for the ball member in the distal element.

16. The method of claim 12, wherein the joining comprises:
attaching a protrusion in the second portion of the distal element to a recess in the first portion of the distal element.

17. The method of claim 12, wherein the joining comprises:
attaching a protrusion in the first portion of the distal element to a recess in the second portion of the distal element.

18. The method of claim 12, wherein the bases of the first portion and the second portion are ridged.

19. The method of claim 12,
wherein the providing comprises additively manufacturing the arm with the mesial element; and
wherein the enclosing further comprises additively manufacturing the first portion and the second portion prior to the inserting and the joining.

20. A method of assembling a distalizer, comprising:
providing an arm with a mesial element at one end of the arm and a ball member at another end of the arm, the mesial element having a first base for attachment to a canine or bicuspid;
enclosing the ball member in a distal element without reducing an opening of a receptacle in the distal element, the receptacle having a shape that is complementary to a shape of the ball member, and the distal element having a second base for attachment to a molar,
wherein the enclosing comprises:
inserting the ball member into a first portion of the distal element; and
joining a second portion of the distal element with the first portion, the first portion and the second portion of the distal element together forming the receptacle, and a base of the first portion and a base of the second portion together comprising the second base of the distal element.
